(19) United States
(12) Patent Application Publication
(10) Pub. No.: US 2024/0170676 A1
(43) Pub. Date: May 23, 2024

(54) ELECTRODE BINDER AND SLURRY COMPOSITIONS FOR LITHIUM ION ELECTRICAL STORAGE DEVICES

(71) Applicant: PPG Industries Ohio, Inc., Cleveland, OH (US)

(72) Inventors: Wenqing Liu, Tianjin (CN); Kevin Thomas Sylvester, Pittsburgh, PA (US); Fanghui Wu, Pittsburgh, PA (US); Scott William Sisco, Glenshaw, PA (US); Pengfei Zhan, Pittsburgh, PA (US)

(73) Assignee: PPG Industries Ohio, Inc., Cleveland, OH (US)

(21) Appl. No.: 18/551,898

(22) PCT Filed: Mar. 25, 2022
(86) PCT No.: PCT/US2022/021934

§ 371 Date: Sep. 22, 2023

Related U.S. Application Data
(60) Provisional application No. 63/200,767, filed on Mar. 26, 2021.

(51) Int. Cl. H01M 4/62; H01M 4/131; H01M 4/505; H01M 4/525; H01M 10/0525; H01G 11/28; H01G 11/30

(52) U.S. Cl. CPC H01M 4/623; H01M 4/131; H01M 4/505; H01M 4/525; H01M 4/625; H01M 10/0525; H01G 11/28; H01G 11/30

(57) ABSTRACT

The present disclosure provides a binder composition comprising (a) at least one fluoropolymer comprising the residue of vinylidene fluoride; (b) one or more (meth)acrylic polymers; and (c) an organic medium comprising a trialkyl phosphate solvent. Also disclosed are slurry compositions, electrodes, and electrical storage devices.

### FIELD

The disclosure relates to fluoropolymer binder compositions and slurries that could be used in manufacturing electrodes for use in electrical storage devices, such as batteries.

### BACKGROUND

There is a trend in the electronics industry to produce smaller devices, powered by smaller and lighter electrical storage devices, such as batteries. Electrical storage devices with a negative electrode, such as those including carbonaceous materials as an electrochemically active material, and a positive electrode, such as those including lithium metal oxides as an electrochemically active material, can provide relatively high power and low weight. Fluoropolymers such as polyvinylidene fluoride (PVDF), because of their excellent electrochemical resistance, have been found to be useful binders for forming electrodes to be used in electrical storage devices. Typically, the PVDF fluoropolymer is dissolved in an organic solvent and the electrode material is combined with the solution to form a slurry that is applied to a metal foil or mesh to form the electrode. The role of the organic solvent is to dissolve the fluoropolymer in order to provide good adhesion between the electrode material particles and the metal foil or mesh upon evaporation of the organic solvent. Currently, the organic solvent of choice is N-methyl-2-pyrrolidone (NMP). PVDF binders dissolved in NMP provide superior adhesion and an interconnectivity of all the active ingredients in the electrode composition. The bound ingredients are able to tolerate large volume expansion and contraction during charge and discharge cycles without losing interconnectivity within the electrodes. Interconnectivity of the active ingredients in an electrode is extremely important in battery performance, especially during charging and discharging cycles, as electrons must move through the electrode, and lithium ion mobility requires interconnectivity within the electrode between particles. Unfortunately, NMP is a toxic material and presents health and environmental issues.

Alternative technologies to NMP have been developed. However, for the alternative technologies to be useful they must be compatible with current manufacturing practices and provide desired properties of the intermediate and final products. Some common criteria include a viscosity of the slurry appropriate to facilitate good application properties, sufficient interconnectivity within the electrode, sufficient adhesion to the underlying substrate, and sufficient durability of the binder for the resulting electrode coating to the electrolyte in the battery.

### BRIEF DESCRIPTION OF THE DRAWINGS

FIG. 1 is a graph showing the viscosity at a range of shear rates of positive electrode slurry compositions prepared in the Examples section and shows the viscosity at a range of shear rates for an initial sample and an aged sample.

FIG. 2 is a graph showing rheology measurements showing viscosity at 10 s⁻¹ shear rate for binders prepared in the Examples section.

### SUMMARY

The present disclosure provides a binder composition comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and (c) an organic medium comprising a trialkyl phosphate solvent.

The present disclosure also provides a slurry composition comprising: a binder composition comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and (c) an organic medium comprising a trialkyl phosphate solvent; and an electrochemically active material.

The present disclosure further provides a slurry composition comprising: a binder composition comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and (c) an organic medium comprising a trialkyl phosphate solvent; and an electrically conductive agent.

The present disclosure also provides an electrode comprising: (A) an electrical current collector; and (B) a film on the electrical current collector, wherein the film comprises: (1) an electrochemically active material; and (2) a binder comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers.

The present disclosure further provides an electrical storage device comprising: (a) an electrode comprising: (A) an electrical current collector; and (B) a film on the electrical current collector, wherein the film comprises: (1) an electrochemically active material; and (2) a binder comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; (b) a counter electrode; and (c) an electrolyte.

### DETAILED DESCRIPTION

The present disclosure is directed to a binder composition comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and (c) an organic medium comprising a trialkyl phosphate solvent. The binder composition may be used in a slurry composition.

According to the present disclosure, the binder composition comprises a fluoropolymer. The fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer comprising, consisting essentially of, or consisting of vinyl halide monomers (such as trifluoroethylene, chlorotrifluoroethylene, hexafluoropropene, vinyl chloride, vinyl fluoride, pentafluoropropene, tetrafluoropropene, and the like), vinyl fluoro ethers having the formula F₂C═CF(OR^{f}) where R^{F} is a fluorinated alkyl chain (such as perfluoromethyl vinyl ether, perfluoropropyl vinyl ether, and the like), (meth)acrylic-based monomers (including any of those described herein), and any other monomer that would readily copolymerize with vinylidene fluoride in order to produce the fluoropolymer. The fluoropolymer may also comprise a PVDF homopolymer.

The fluoropolymer may have a weight average molecular weight of at least 50,000 g/mol, such as at least 100,000 g/mol, such as at least 250,000 g/mol, such as at least 300,000 g/mol, such as at least 350,000 g/mol, such as at least 400,000 g/mol, such as at least 450,000 g/mol, such as at least 500,000 g/mol, such as at least 550,000 g/mol, such as 600,000 g/mol, such as at least 650,000 g/mol, such as at least 700,000 g/mol, such as at least 750,000 g/mol, such as at least 800,000 g/mol, such as at least 850,000 g/mol, such as at least 900,000 g/mol, such as at least 950,000 g/mol, such as at least 1,000,000 g/mol, such as at least 1,050,000 g/mol, such as at least 1,100,000 g/mol, such as at least 1,150,000 g/mol, such as at least 1,200,000 g/mol, such as at least 1,250,000 g/mol. The fluoropolymer may have a weight average molecular weight of no more than 1,500,000 g/mol, such as no more than 1,250,000 g/mol, such as no more than 1,200,000 g/mol, such as no more than 1,150,000 g/mol, such as no more than 1,100,000 g/mol, such as no more than 1,050,000 g/mol, such as no more than 1,000,000 g/mol, such as no more than 950,000 g/mol, such as no more than 900,000 g/mol, such as no more than 850,000 g/mol, such as no more than 800,000 g/mol, such as no more than 750,000 g/mol, such as no more than 700,000 g/mol, such as no more than 650,000 g/mol, such as no more than 600,000 g/mol, such as no more than 550,000 g/mol, such as no more than 500,000 g/mol, such as no more than 450,000 g/mol, such as no more than 400,000 g/mol, such as no more than 350,000 g/mol, such as no more than 300,000 g/mol. The fluoropolymer may have a weight average molecular weight of 50,000 to 1,500,000 g/mol, such as 250,000 to 700,000 g/mol, such as 250,000 to 650,000 g/mol, such as 250,000 to 600,000 g/mol, such as 250,000 to 550,000 g/mol, such as 250,000 to 500,000 g/mol, such as 250,000 to 450,000 g/mol, such as 250,000 to 400,000 g/mol, such as 250,000 to 350,000 g/mol, such as 250,000 to 300,000 g/mol, such as 300,000 to 700,000 g/mol, such as 300,000 to 650,000 g/mol, such as 300,000 to 600,000 g/mol, such as 300,000 to 550,000 g/mol, such as 300,000 to 500,000 g/mol, such as 300,000 to 450,000 g/mol, such as 300,000 to 400,000 g/mol, such as 300,000 to 350,000 g/mol, such as such as 350,000 to 700,000 g/mol, such as 350,000 to 650,000 g/mol, such as 350,000 to 600,000 g/mol, such as 350,000 to 550,000 g/mol, such as 350,000 to 500,000 g/mol, such as 350,000 to 450,000 g/mol, such as 350,000 to 400,000 g/mol, such as 400,000 to 700,000 g/mol, such as 400,000 to 650,000 g/mol, such as 400,000 to 600,000 g/mol, such as 400,000 to 550,000 g/mol, such as 400,000 to 500,000 g/mol, such as 400,000 to 450,000 g/mol, such as 450,000 to 700,000 g/mol, such as 450,000 to 650,000 g/mol, such as 450,000 to 600,000 g/mol, such as 450,000 to 550,000 g/mol, such as 450,000 to 500,000 g/mol, such as 500,000 to 700,000 g/mol, such as 500,000 to 650,000 g/mol, such as 500,000 to 600,000 g/mol, such as 500,000 to 550,000 g/mol, such as 550,000 to 700,000 g/mol, such as 550,000 to 650,000 g/mol, such as 550,000 to 600,000 g/mol, such as 600,000 to 700,000 g/mol, such as 600,000 to 650,000 g/mol, such as 650,000 to 700,000 g/mol, such as 750,000 to 1,500,000 g/mol, such as 750,000 to 1,250,000 g/mol, such as 750,000 to 1,200,000 g/mol, such as 750,000 to 1,150,000 g/mol, such as 750,000 to 1,100,000 g/mol, such as 750,000 to 1,050,000 g/mol, such as 750,000 to 1,000,000 g/mol, such as 750,000 to 950,000 g/mol, such as 750,000 to 900,000 g/mol, such as 750,000 to 850,000 g/mol, such as 750,000 to 800,000 g/mol, such as 800,000 to 1,500,000 g/mol, such as 800,000 to 1,250,000 g/mol, such as 800,000 to 1,200,000 g/mol, such as 800,000 to 1,150,000 g/mol, such as 800,000 to 1,100,000 g/mol, such as 800,000 to 1,050,000 g/mol, such as 800,000 to 1,000,000 g/mol, such as 800,000 to 950,000 g/mol, such as 800,000 to 900,000 g/mol, such as 800,000 to 850,000 g/mol, such as 850,000 to 1,500,000 g/mol, such as 850,000 to 1,250,000 g/mol, such as 850,000 to 1,200,000 g/mol, such as 850,000 to 1,150,000 g/mol, such as 850,000 to 1,100,000 g/mol, such as 850,000 to 1,050,000 g/mol, such as 850,000 to 1,000,000 g/mol, such as 850,000 to 950,000 g/mol, such as 850,000 to 900,000 g/mol, such as 900,000 to 1,500,000 g/mol, such as 900,000 to 1,250,000 g/mol, such as 900,000 to 1,200,000 g/mol, such as 900,000 to 1,150,000 g/mol, such as 900,000 to 1,100,000 g/mol, such as 900,000 to 1,050,000 g/mol, such as 900,000 to 1,000,000 g/mol, such as 900,000 to 950,000 g/mol, such as 950,000 to 1,500,000 g/mol, such as 950,000 to 1,250,000 g/mol, such as 950,000 to 1,200,000 g/mol, such as 950,000 to 1,150,000 g/mol, such as 950,000 to 1,100,000 g/mol, such as 950,000 to 1,050,000 g/mol, such as 950,000 to 1,000,000 g/mol, such as 1,000,000 to 1,500,000 g/mol, such as 1,000,000 to 1,250,000 g/mol, such as 1,000,000 to 1,200,000 g/mol, such as 1,000,000 to 1,150,000 g/mol, such as 1,000,000 to 1,100,000 g/mol, such as 1,000,000 to 1,050,000 g/mol, such as 1,050,000 to 1,500,000 g/mol, such as 1,050,000 to 1,250,000 g/mol, such as 1,050,000 to 1,200,000 g/mol, such as 1,050,000 to 1,150,000 g/mol, such as 1,050,000 to 1,100,000 g/mol, such as 1,100,000 to 1,500,000 g/mol, such as 1,100,000 to 1,250,000 g/mol, such as 1,100,000 to 1,200,000 g/mol, such as 1,100,000 to 1,150,000 g/mol, such as 1,150,000 to 1,500,000 g/mol, such as 1,150,000 to 1,250,000 g/mol, such as 1,150,000 to 1,200,000 g/mol, such as 1,200,000 to 1,500,000 g/mol, such as 1,200,000 to 1,250,000 g/mol, such as 1,250,000 to 1,500,000 g/mol. A combination of fluoropolymers having different molecular weights may be used. PVDF is commercially available, e.g., from Arkema under the trademark KYNAR from Solvay under the trademark HYLAR, and from Inner Mongolia 3F Wanhao Fluorochemical Co., Ltd.

The fluoropolymer used in preparing the binder may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 900 nm, such as no more than 600 nm, such as no more than 450 nm, such as no more than 400 nm, such as no more than 300 nm, such as no more than 200 nm. The fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the fluoropolymer particles. The particle size referred to was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

The fluoropolymer may be present in in the binder in amounts of at least 40% by weight, such as at least 50% by weight, such as at least 60% by weight, such as at least 70% by weight, such as at least 80% by weight, such as at least 85% by weight, such as at least 90% by weight, such as at least 95% by weight, such as at least 98% by weight, based on the total weight of the binder solids. The fluoropolymer may be present in in the binder in amounts of no more than 99% by weight, such as no more than 98% by weight, such as no more than 96% by weight, such as no more than 95% by weight, such as no more than 90% by weight, such as no more than 85% by weight, such as no more than 80% by weight, based on the total weight of the binder solids. The fluoropolymer may be present in in the binder in amounts of 40% to 99% by weight, such as 40% to 98% by weight, such as 40% to 96% by weight, such as 40% to 95% by weight, such as 40% to 90% by weight, such as 40% to 85% by weight, such as 40% to 80% by weight, such as 50% to 99% by weight, such as 50% to 98% by weight, such as 50% to 96% by weight, such as 50% to 95% by weight, such as 50% to 90% by weight, such as 50% to 85% by weight, such as 50% to 80% by weight, such as 60% to 99% by weight, such as 60% to 98% by weight, such as 60% to 96% by weight, such as 60% to 95% by weight, such as 60% to 90% by weight, such as 60% to 85% by weight, such as 60% to 80% by weight, such as 70% to 99% by weight, such as 70% to 98% by weight, such as 70% to 96% by weight, such as 70% to 95% by weight, such as 70% to 90% by weight, such as 70% to 85% by weight, such as 70% to 80% by weight, such as 80% to 99% by weight, such as 80% to 98% by weight, such as 80% to 96% by weight, such as 80% to 95% by weight, such as 80% to 90% by weight, such as 80% to 85% by weight, such as 85% to 99% by weight, such as 85% to 98% by weight, such as 85% to 96% by weight, such as 85% to 95% by weight, such as 85% to 90% by weight, such as 90% to 99% by weight, such as 90% to 98% by weight, such as 90% to 96% by weight, such as 95% to 99% by weight, such as 95% to 98% by weight, such as 95% to 96% by weight, such as 98% to 99% by weight, based on the total weight of the binder solids.

The binder composition and/or slurry composition further comprise a (meth)acrylic polymer. The binder composition and/or slurry composition may comprise one, two, three, four or more different (meth)acrylic polymers. The (meth)acrylic polymer may be in the form of a block polymer, a random polymer, or a gradient polymer.

The (meth)acrylic may comprise functional groups. The functional groups may comprise, for example, active hydrogen functional groups, heterocyclic groups, and combinations thereof. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, aziridines, thioepoxides, lactams and lactones. In addition, when epoxide functional groups are present on the (meth)acrylic polymer, the epoxide functional groups on the (meth)acrylic polymer optionally may be post-reacted with a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the (meth)acrylic.

The (meth)acrylic polymer may comprise constitutional units comprising the residue of one or more (meth)acrylic monomers. The (meth)acrylic polymer may be prepared by polymerizing a reaction mixture of alpha, beta-ethylenically unsaturated monomers that comprise one or more (meth)acrylic monomers and optionally other ethylenically unsaturated monomers. As used herein, the term “(meth)acrylic monomer” refers to acrylic acid, methacrylic acid, and monomers derived therefrom, including alkyl esters of acrylic acid and methacrylic acid, and the like. As used herein, the term “(meth)acrylic polymer” refers to a polymer derived from or comprising constitutional units comprising the residue of one or more (meth)acrylic monomers. The mixture of monomers may comprise one or more active hydrogen group-containing (meth)acrylic monomers, ethylenically unsaturated monomers comprising a heterocyclic group, and other ethylenically unsaturated monomers. The (meth)acrylic polymer may also be prepared with an epoxy functional ethylenically unsaturated monomer such as glycidyl methacrylate in the reaction mixture, and epoxy functional groups on the resulting polymer may be post-reacted with a beta-hydroxy functional acid such as citric acid, tartaric acid, and/or 3-hydroxy-2-naphthoic acid to yield hydroxyl functional groups on the (meth)acrylic polymer.

The (meth)acrylic polymer may comprise constitutional units comprising the residue of an alkyl esters of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 30% by weight, such as at least 35% by weight, such as at least 40% by weight, such as at least 45% by weight, such as at least 47.5% by weight, based on the total weight of the (meth)acrylic polymer. The constitutional units comprising the residue of the alkyl esters of (meth)acrylic acid containing from 1 to 3 carbon atoms in the alkyl group may comprise no more than 96%, such as no more than 90%, such as no more than 85%, such as no more than 80%, such as no more than 75%, such as no more than 70%, such as no more than 65%, based on the total weight of the (meth)acrylic polymer. The constitutional units comprising the residue of the alkyl esters of (meth)acrylic acid containing from 1 to 3 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the (meth)acrylic polymer. The (meth)acrylic polymer may be derived from a reaction mixture comprising the alkyl esters of (meth)acrylic acid containing from 1 to 3 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture.

The (meth)acrylic polymer may comprise constitutional units comprising the residue of an alkyl esters of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 18% by weight, such as at least 18% by weight. The constitutional units comprising the residue of the alkyl esters of (meth)acrylic acid containing from 4 to 18 carbon atoms in the alkyl group may comprise no more than 60% by weight, such as no more than 50% by weight, such as no more than 45% by weight, such as no more than 40% by weight, such as no more than 35% by weight, based on the total weight of the (meth)acrylic polymer. The constitutional units comprising the residue of the alkyl esters of (meth)acrylic acid containing from 4 to 18 carbon atoms in the alkyl group may comprise 2% to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of the (meth)acrylic polymer. The (meth)acrylic polymer may be derived from a reaction mixture comprising the alkyl esters of (meth)acrylic acid containing from 4 to 18 carbon atoms in the alkyl group in an amount of % to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of polymerizable monomers used in the reaction mixture.

The (meth)acrylic polymer may comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 1.5% by weight, based on the total weight of the (meth)acrylic polymer. The constitutional units comprising the residue of the hydroxyalkyl ester may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the hydroxyalkyl ester may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the hydroxyalkyl ester in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of a hydroxyalkyl ester in the (meth)acrylic polymer results in a (meth)acrylic polymer comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the (meth)acrylic polymer when self-crosslinking monomers that have groups that are reactive with the hydroxyl groups are incorporated into the (meth)acrylic polymer.

The (meth)acrylic polymer may optionally comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. If present, the constitutional units comprising the residue of the alpha, beta-ethylenically unsaturated carboxylic acids may comprise at least 0.5% by weight, such as at least 1% by weight, such as at least 1.5% by weight, based on the total weight of the (meth)acrylic polymer. If present, the constitutional units comprising the residue of the alpha, beta-ethylenically unsaturated carboxylic acids may comprise no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the alpha, beta-ethylenically unsaturated carboxylic acids may comprise 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the alpha, beta-ethylenically unsaturated carboxylic acids in an amount of 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of an alpha, beta-ethylenically unsaturated carboxylic acids in the (meth)acrylic polymer results in a (meth)acrylic polymer comprising at least one carboxylic acid group.

When acid functional groups are present, the (meth)acrylic polymer may have a theoretical acid equivalent weight of at least 350 grams/equivalent, such as at least 878 grams/equivalent, such as at least 1,757 grams/equivalent, and may be no more than 17,570 grams/equivalent, such as no more than 12,000 grams/equivalent, such as no more than 7,000 grams/equivalent. The (meth)acrylic polymer may have a theoretical acid equivalent weight of 350 to 17,570 grams/equivalent, such as 878 to 12,000 grams/equivalent, such as 1,757 to 7,000 grams/equivalent.

The (meth)acrylic polymer optionally may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers, such as glycidyl (meth)acrylate, vinyl pyrrolidone and vinyl caprolactam, among others. The constitutional units comprising the residue of the ethylenically unsaturated monomers comprising a heterocyclic group may, if present, comprise at least 0.5% by weight, such as at least 1% by weight, such as at least 2% by weight, such as at least 3% by weight, such as at least 4% by weight, such as at least 5% by weight, such as at least 8% by weight, based on the total weight of the (meth)acrylic polymer. The constitutional units comprising the residue of the ethylenically unsaturated monomers comprising a heterocyclic group may, if present, comprise no more than 50% by weight, such as no more than 40% by weight, such as no more than 27% by weight, such as no more than 20% by weight, such as no more than 15% by weight, such as no more than 10% by weight, based on the total weight of the (meth)acrylic polymer. The constitutional units comprising the residue of the ethylenically unsaturated monomers comprising a heterocyclic group may comprise 0% to 50% by weight, such as 0.5% to 50% by weight, such as 0.5% to 40% by weight, such as 0.5% to 27% by weight, such as 0.5% to 20% by weight, such as 0.5% to 15% by weight, such as 0.5% to 10% by weight, such as 1% to 50% by weight, such as 1% to 40% by weight, such as 1% to 27% by weight, such as 1% to 20% by weight, such as 1% to 15% by weight, such as 1% to 10% by weight, such as 2% to 50% by weight, such as 2% to 40% by weight, such as 2% to 27% by weight, such as 2% to 20% by weight, such as 2% to 15% by weight, such as 2% to 10% by weight, such as 3% to 50% by weight, such as 3% to 40% by weight, such as 3% to 27% by weight, such as 3% to 20% by weight, such as 3% to 15% by weight, such as 3% to 10% by weight, such as 4% to 50% by weight, such as 4% to 40% by weight, such as 4% to 27% by weight, such as 4% to 20% by weight, such as 4% to 15% by weight, such as 4% to 10% by weight, such as 5% to 50% by weight, such as 5% to 40% by weight, such as 5% to 27% by weight, such as 5% to 20% by weight, such as 5% to 15% by weight, such as 5% to 10% by weight, such as 8% to 50% by weight, such as 8% to 40% by weight, such as 8% to 27% by weight, such as 8% to 20% by weight, such as 8% to 15% by weight, such as 8% to 10% by weight, based on the total weight of the (meth)acrylic polymer. The (meth)acrylic polymer may be derived from a reaction mixture comprising the ethylenically unsaturated monomers comprising a heterocyclic group in an amount of such as 0.5% to 50% by weight, such as 0.5% to 40% by weight, such as 0.5% to 27% by weight, such as 0.5% to 20% by weight, such as 0.5% to 15% by weight, such as 0.5% to 10% by weight, such as 1% to 50% by weight, such as 1% to 40% by weight, such as 1% to 27% by weight, such as 1% to 20% by weight, such as 1% to 15% by weight, such as 1% to 10% by weight, such as 2% to 50% by weight, such as 2% to 40% by weight, such as 2% to 27% by weight, such as 2% to 20% by weight, such as 2% to 15% by weight, such as 2% to 10% by weight, such as 3% to 50% by weight, such as 3% to 40% by weight, such as 3% to 27% by weight, such as 3% to 20% by weight, such as 3% to 15% by weight, such as 3% to 10% by weight, such as 4% to 50% by weight, such as 4% to 40% by weight, such as 4% to 27% by weight, such as 4% to 20% by weight, such as 4% to 15% by weight, such as 4% to 10% by weight, such as 5% to 50% by weight, such as 5% to 40% by weight, such as 5% to 27% by weight, such as 5% to 20% by weight, such as 5% to 15% by weight, such as 5% to 10% by weight, such as 8% to 50% by weight, such as 8% to 40% by weight, such as 8% to 27% by weight, such as 8% to 20% by weight, such as 8% to 15% by weight, such as 8% to 10% by weight, based on the total weight of polymerizable monomers used in the reaction mixture.

As noted above, the (meth)acrylic polymer may comprise constitutional units comprising the residue of a self-crosslinking monomer, and the (meth)acrylic polymer may comprise a self-crosslinking (meth)acrylic polymer. As used herein, the term “self-crosslinking monomer” refers to monomers that incorporate functional groups that may react with other functional groups present on the (meth)acrylic polymer to a crosslink between the (meth)acrylic polymer or more than one (meth)acrylic polymer. Non-limiting examples of self-crosslinking monomers include N-alkoxymethyl (meth)acrylamide monomers such as N-butoxymethyl (meth)acrylamide and N-isopropoxymethyl (meth)acrylamide, as well as self-crosslinking monomers containing blocked isocyanate groups, such as isocyanatoethyl (meth)acrylate in which the isocyanato group is reacted (“blocked”) with a compound that unblocks at curing temperature. Examples of suitable blocking agents include epsilon-caprolactone and methylethyl ketoxime. The constitutional units comprising the residue of the self-crosslinking monomer may comprise at least 0.5% by weight, such as at least 1% by weight, such as at least 1.5% by weight, based on the total weight of the (meth)acrylic polymer. The constitutional units comprising the residue of the self-crosslinking monomer may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the self-crosslinking monomer may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the self-crosslinking monomer in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The (meth)acrylic polymer may comprise constitutional units comprising the residue of other alpha, beta-ethylenically unsaturated monomers. Non-limiting examples of other alpha, beta-ethylenically unsaturated monomers include vinyl aromatic compounds such as styrene, alpha-methyl styrene, alpha-chlorostyrene and vinyl toluene; organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least at least 0.5% by weight, such as at least 1% by weight, such as at least 1.5% by weight, based on the total weight of the (meth)acrylic polymer. The constitutional units comprising the residue of the other alpha, beta-ethylenically unsaturated monomers may comprise 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The monomers and relative amounts may be selected such that the resulting (meth)acrylic polymer has a Tg of 100° C. or less. The resulting (meth)acrylic polymer may have a Tg of, for example, at least −50° C., such as at least −40° C., such as −30° C., such as, −20° C., such as −15° C., such as −10° C., such as −5° C., such as 0° C. The resulting (meth)acrylic polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting (meth)acrylic polymer may have a Tg of, for example, −50 to +70° C., such as −50 to +60° C., such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +50° C., such as 0 to +40° C., such as 0 to +25° C., such as 0 to +20° C., such as 0 to +15° C. A lower Tg that is below 0° C. may be desirable to ensure acceptable battery performance at low temperature.

The (meth)acrylic polymer may have a number average molecular weight of at least 2,500 g/mol, such as at least 5,000 g/mol, such as at least 7,500 g/mol, such at least 10,000 g/mol. The (meth)acrylic polymer may have a number average molecular weight of no more than 100,000 g/mol, such as no more than 75,000 g/mol, such as no more than 50,000 g/mol, such as no more than 25,000 g/mol, such as no more than 20,000 g/mol, such as no more than 15,000 g/mol, such as no more than 10,000 g/mol, such as no more than 7,500 g/mol. The (meth)acrylic polymer may have a number average molecular weight of 2,500 to 100,000 g/mol, such as 2,500 to 75,000 g/mol, such as 2,500 to 50,000 g/mol, such as 2,500 to 25,000 g/mol, such as 2,500 to 20,000 g/mol, such as 2,500 to 15,000 g/mol, such as 2,500 to 12,500 g/mol, such as 2,500 to 10,000 g/mol, such as 2,500 to 7,500 g/mol, 5,000 to 100,000 g/mol, such as 5,000 to 75,000 g/mol, such as 5,000 to 50,000 g/mol, such as 5,000 to 25,000 g/mol, such as 5,000 to 20,000 g/mol, such as 5,000 to 15,000 g/mol, such as 5,000 to 12,500 g/mol, such as 5,000 to 10,000 g/mol, such as 5,000 to 7,500 g/mol, 7,500 to 100,000 g/mol, such as 7,500 to 75,000 g/mol, such as 7,500 to 50,000 g/mol, such as 7,500 to 25,000 g/mol, such as 7,500 to 20,000 g/mol, such as 7,500 to 15,000 g/mol, such as 7,500 to 12,500 g/mol, such as 7,500 to 10,000 g/mol, 10,000 to 100,000 g/mol, such as 10,000 to 75,000 g/mol, such as 10,000 to 50,000 g/mol, such as 10,000 to 25,000 g/mol, such as 10,000 to 20,000 g/mol, such as 10,000 to 15,000 g/mol, such as 10,000 to 12,500 g/mol.

The (meth)acrylic polymer may have a weight average molecular weight of at least at least 5,000 g/mol, such as at least 10,000 g/mol, such as at least 15,000 g/mol, such at least 20,000 g/mol. The (meth)acrylic polymer may have a weight average molecular weight of no more than 200,000 g/mol, such as no more than 150,000 g/mol, such as no more than 100,000 g/mol, such as no more than 50,000 g/mol, such as no more than 40,000 g/mol, such as no more than 30,000 g/mol, such as no more than 20,000 g/mol, such as no more than 15,000 g/mol. The (meth)acrylic polymer may have a weight average molecular weight of 5,000 to 200,000 g/mol, such as 5,000 to 150,000 g/mol, such as 5,000 to 100,000 g/mol, such as 5,000 to 50,000 g/mol, such as 5,000 to 40,000 g/mol, such as 5,000 to 30,000 g/mol, such as 5,000 to 25,000 g/mol, such as 5,000 to 20,000 g/mol, such as 5,000 to 15,000 g/mol, 10,000 to 200,000 g/mol, such as 10,000 to 150,000 g/mol, such as 10,000 to 100,000 g/mol, such as 10,000 to 50,000 g/mol, such as 10,000 to 40,000 g/mol, such as 10,000 to 30,000 g/mol, such as 10,000 to 25,000 g/mol, such as 10,000 to 20,000 g/mol, such as 10,000 to 15,000 g/mol, 15,000 to 200,000 g/mol, such as 15,000 to 150,000 g/mol, such as 15,000 to 100,000 g/mol, such as 15,000 to 50,000 g/mol, such as 15,000 to 40,000 g/mol, such as 15,000 to 30,000 g/mol, such as 15,000 to 25,000 g/mol, such as 15,000 to 20,000 g/mol, 20,000 to 200,000 g/mol, such as 20,000 to 150,000 g/mol, such as 20,000 to 100,000 g/mol, such as 20,000 to 50,000 g/mol, such as 20,000 to 40,000 g/mol, such as 20,000 to 30,000 g/mol, such as 20,000 to 25,000 g/mol.

The (meth)acrylic polymer s may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the mixture of monomers such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications. Tertiary-dodecyl mercaptan is preferred because it results in high conversion of monomer to polymeric product.

To prepare the (meth)acrylic polymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

The (meth)acrylic polymers prepared as described above may have a weight average molecular weight of about 5,000 to 500,000 g/mol, such as 10,000 to 100,000 g/mol, and 25,000 to 50,000 g/mol.

The (meth)acrylic polymer may be present in the binder in amounts of at least 1% by weight, such as at least 2% by weight, such as at least 3% by weight, such as at least 4% by weight, such as at least 5% by weight, based on the total weight of the binder solids. The (meth)acrylic polymer may be present in the binder in amounts of no more than 20% by weight, such as no more than 15% by weight, such as no more than 12.5% by weight, such as no more than 10% by weight, such as no more than 5% by weight, based on the total weight of the binder solids. The (meth)acrylic polymer may be present in the binder in amounts of 1% to 20% by weight, such as 1% to 15% by weight, such as 1% to 12.5% by weight, such as 1% to 10% by weight, such as 1% to 5% by weight, such as 2% to 20% by weight, such as 2% to 15% by weight, such as 2% to 12.5% by weight, such as 2% to 10% by weight, such as 2% to 5% by weight, such as 3% to 20% by weight, such as 3% to 15% by weight, such as 3% to 12.5% by weight, such as 3% to 10% by weight, such as 3% to 5% by weight, such as 4% to 20% by weight, such as 4% to 15% by weight, such as 4% to 12.5% by weight, such as 4% to 10% by weight, such as 4% to 5% by weight, such as 5% to 20% by weight, such as 5% to 15% by weight, such as 5% to 12.5% by weight, such as 5% to 10% by weight, based on the total weight of the binder solids.

The binder composition and/or slurry composition further comprises an organic medium comprising, consisting essentially of, or consisting of a trialkyl phosphate solvent. As used herein, the term “organic medium” refers to a liquid medium comprising less than 50% by weight water, based on the total weight of the organic medium. Such organic mediums may comprise less than 45% by weight water, such as less than 40% by weight water, such as less than 45% by weight water, such as less than 30% by weight water, such as less than 25% by weight water, such as less than 20% by weight water, such as less than 15% by weigh water, such as less than 10% by weight water, such as less than 5% by weight water, such as less than 2.5% by weight water, such as less than 1% by weight water, such as less than 0.1% by weight water, based on the total weight of the organic medium. Alternatively, the organic medium may be free of water, i.e., 0.00% by weight water. Organic solvent(s) comprise more than 50% by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

The trialkyl phosphate may comprise, for example, trimethylphosphate, triethylphosphate, tripropylphosphate, tributylphosphate, or the like, or combinations thereof.

The organic medium may optionally comprise a co-solvent. The co-solvent may comprise butyl pyrrolidone, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or any combination thereof.

The fluoropolymer of the binder compositions and/or slurry composition may be solubilized or solved in the trialkyl phosphate solvent at room temperature, i.e., about 23° C., and pressure.

The organic medium may be present in an amount of at least 10% by weight, such as at least 15% by weight, such as at least 20% by weight, such as at least 30% by weight, such as at least 35% by weight, such as at least 40% by weight, and may be present in an amount of no more than 80% by weight, such as no more than 70% by weight, such as no more than 60% by weight, such as no more than 50% by weight, such as no more than 45% by weight, such as no more than 45% by weight, such as no more than 40% by weight, such as no more than 35% by weight, such as no more than 29% by weight, such as no more than 25% by weight, based on the total weight of the binder composition and/or slurry composition. The organic medium may be present in an amount of such as 20% to 80% by weight, 10% to 70% by weight, such as 30% to 70% by weight, such as 35% to 60% by weight, such as 40% to 50% by weight, 15% to 60% by weight, 15% to 50% by weight, 15% to 45% by weight, 15% to 40% by weight, 15% to 35% by weight, 15% to 29% by weight, 15% to 25% by weight, based on the total weight of the binder composition and/or slurry composition.

The binder composition and/or slurry composition may be substantially free, essentially free, or completely free of N-Methyl-2-pyrrolidone (NMP). As used herein, the binder composition and/or slurry composition is “substantially free” of NMP if NMP is present, if at all, in an amount of less than 5% by weight, based on the total weight of the binder composition and/or slurry composition. As used herein, the binder composition and/or slurry composition is “essentially free” of NMP if NMP is present, if at all, in an amount of less than 0.3% by weight, based on the total weight of the binder composition and/or slurry composition. As used herein, the slurry composition is “completely free” of NMP if NMP is not present in the binder composition and/or slurry composition, i.e., 0.000% by weight, based on the total weight of the binder composition and/or slurry composition.

The binder composition and/or slurry composition may be substantially free, essentially free, or completely free of ketones such as methyl ethyl ketone, cyclohexanone, isophorone, acetophenone.

The binder composition and/or slurry composition may be substantially free, essentially free, or completely free of ethers such as the C₁ to C₄ alkyl ethers of ethylene or propylene glycol.

The fluoropolymer, binder composition and/or slurry composition may be substantially free, essentially free, or completely free of fluoroethylene, such as tetrafluoroethylene.

The fluoropolymer, binder composition and/or slurry composition may be substantially free, essentially free, or completely free of fluorosurfactant.

The binder composition and/or slurry composition may be substantially free, essentially free, or completely free of siloxane.

As noted above, the binder composition and/or slurry composition may optionally further comprise a separately added crosslinking agent for reaction with the (meth)acrylic polymer. The crosslinking agent should be soluble or dispersible in the organic medium and be reactive with active hydrogen groups of the (meth)acrylic polymer, such as the carboxylic acid groups and the hydroxyl groups, if present. Non-limiting examples of suitable crosslinking agents include aminoplast resins, blocked polyisocyanates and polyepoxides.

Examples of aminoplast resins for use as a crossslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Carbodiimide crosslinking agents may be in monomeric or polymeric form, or a mixture thereof. Carbodiimide crosslinking agents refer to compounds having the following structure:

R—N═C═N—R′

wherein R and R′ may each individually comprise an aliphatic, aromatic, alkylaromatic, carboxylic, or heterocyclic group. Examples of commercially available carbodiimide crosslinking agents include, for example, those sold under the trade name CARBODILITE available from Nisshinbo Chemical Inc., such as CARBODILITE V-02-L2, CARBODILITE SV-02, CARBODILITE E-02, CARBODILITE SW-12G, CARBODILITE V-10 and CARBODILITE E-05.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

In addition to promoting the cross-linking of the (meth)acrylic polymer, the crosslinking agents, including those associated with crosslinking monomers and separately added crosslinking agents, react with the hydrophilic groups, such as active hydrogen functional groups of the (meth)acrylic polymer preventing these groups from absorbing moisture that could be problematic in a lithium ion battery.

The separately added crosslinker may be present in the binder in amounts of up to 15% by weight, such as 1% to 15% by weight, the % by weight being based on the total weight of the binder solids.

The binder composition and/or slurry composition may optionally further comprise an adhesion promoter. The adhesion promoter may comprise a portion or all of the fluoropolymer of the binder composition and/or slurry composition. The adhesion promoter may comprise a polyvinylidene fluoride copolymer different than the fluoropolymer described above, or a thermoplastic material.

The polyvinylidene fluoride copolymer adhesion promoter comprises constitutional units comprising the residue of vinylidene fluoride and at least one of (i) a (meth)acrylic acid; and/or (ii) a hydroxyalkyl (meth)acrylate. The (meth)acrylic acid may comprise acrylic acid, methacrylic acid, or combinations thereof. The hydroxyalkyl (meth)acrylate may comprise a C₁ to C₅ hydroxyalkyl (meth)acrylate, such as, for example, hydroxyethyl (meth)acrylate, 2-hydroxypropyl (meth)acrylate, 2-hydroxybutyl (meth)acrylate, or combinations thereof. A commercially available example of such an addition polymer includes SOLEF 5130, available from Solvay. The polyvinylidene fluoride copolymer may be dispersed or solubilized in the organic medium of the binder composition and/or slurry composition.

The polyvinylidene fluoride copolymer adhesion promoter may have a weight average molecular weight as described above with respect to the fluoropolymer.

The adhesion promoter may be present in the binder composition and/or slurry composition in an amount of up to 100% by weight, such as 10% to 60% by weight, 20% to 60% by weight, such as 30% to 60% by weight, such as 10% to 50% by weight, such as 15% to 40% by weight, such as 20% to 30% by weight, such as 30% to 35% by weight, based on the total weight of the binder solids.

The coating film produced from the binder composition and/or slurry composition comprising an adhesion promoter may possess improved adhesion to the current collector compared to a coating film produced from a binder composition and/or slurry composition that does not include the adhesion promoter. For example, the use of the coating film resulting from the binder composition and/or slurry composition comprising an adhesion promoter may improve adhesion by at least 50%, such as at least 100%, such as at least 200%, such as at least 300%, such as at least 400%, compared to a coating film produced from a binder composition and/or slurry composition that does not include the adhesion promoter.

The binder composition may have a resin solids content of from 30% to 80% by weight, such as 40% to 70% by weight, based on the total weight of the binder composition. As used herein, the term “resin solids” may be used synonymously with “binder solids” and include the fluoropolymer, (meth)acrylic polymer, and, if present, adhesion promoter, and separately added crosslinking agent. As used herein, the term “binder composition” refers to a dispersion of the binder solids in the organic medium. The fluoropolymer may be present in the binder composition and/or slurry composition in amounts of 40% to 96% by weight, such as 50% to 90% by weight; the (meth)acrylic polymer may be present in amounts of 2% to 20% by weight, such as 5% to 15% by weight; the adhesion promoter may be present in the binder composition and/or slurry composition in an amount of 10% to 60% by weight, 20% to 60% by weight, such as 30% to 60% by weight, such as 10% to 50% by weight, such as 15% to 40% by weight, such as 20% to 30% by weight, such as 35% to 35% by weight; and the separately added crosslinker may be present in amounts of up to 15% by weight, such as 1% to 15% by weight, the % by weight being based on the total weight of the binder solids. The organic medium is present in the binder composition and/or slurry composition in amounts of 10% to 70% by weight, such as 10% to 65% by weight, such as 15% to 60% by weight, such as 15% to 40% by weight, such as 30% to 60% by weight, based on total weight of the binder composition and/or slurry composition.

The binder solids may be present in the slurry composition in amounts of at least 0.1% by weight, such as at least 0.5% by weight, such as at least 1% by weight, such as at least 1.5% by weight, such as at least 2% by weight, based on the total solids weight of the slurry. The binder solids may be present in the slurry composition in amounts of no more than 20% by weight, such as no more than 15% by weight, such as no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, based on the total solids weight of the slurry.

The fluoropolymer may be present in the slurry composition in an amount of 0.1% to 10% by weight, such as 1% to 6% by weight, such as 1.3% to 4.5% by weight, such as 1.9% to 2.9% by weight, based on the total solids weight of the slurry composition.

The (meth)acrylic polymer may be present in the slurry composition in an amount of 0.1% to 10% by weight, such as 1% to 6% by weight, such as 1.3% to 4.5% by weight, such as 1.9% to 2.9% by weight, based on the total solids weight of the slurry composition.

The separately added crosslinking agent may be present in the slurry composition in an amount of 0.001% to 5% by weight, such as 0.002% to 2% by weight, such as 0.002 to 1% by weight, such as 0.005 to 0.5% by weight, such as 0.005 to 0.3% by weight, such as 0.1% to 5% by weight, based on the total solids weight of the slurry composition.

The present disclosure is also directed to a slurry composition comprising the binder composition described above.

The slurry composition may optionally further comprise an electrochemically active material. The material constituting the electrochemically active material contained in the slurry is not particularly limited and a suitable material can be selected according to the type of an electrical storage device of interest.

The electrochemically active material may comprise a material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O₄, and combinations thereof.

The electrochemically active material may comprise a material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 91% to 99% by weight, such as 94% to 99% by weight, such as 95% to 99% by weight, such as 96% to 99% by weight, such as 97% to 99% by weight, such as 98% to 99% by weight, such as 45% to 98% by weight, such as 50% to 98% by weight, such as 55% to 98% by weight, such as 60% to 98% by weight, such as 65% to 98% by weight, such as 70% to 98% by weight, such as 75% to 98% by weight, such as 80% to 98% by weight, such as 85% to 98% by weight, such as 90% to 98% by weight, such as 91% to 98% by weight, such as 94% to 98% by weight, such as 95% to 98% by weight, such as 96% to 98% by weight, such as 97% to 98% by weight, such as 45% to 96% by weight, such as 50% to 96% by weight, such as 55% to 96% by weight, such as 60% to 96% by weight, such as 65% to 96% by weight, such as 70% to 96% by weight, such as 75% to 96% by weight, such as 80% to 96% by weight, such as 85% to 96% by weight, such as 90% to 96% by weight, such as 91% to 96% by weight, such as 94% to 96% by weight, such as 95% to 96% by weight, based on the total solids weight of the slurry.

The slurry composition may optionally further comprise an electrically conductive agent. Non-limiting examples of electrically conductive agents include carbonaceous materials such as, activated carbon, carbon black such as acetylene black and furnace black, graphite, graphene, carbon nanotubes, carbon fibers, fullerene, and combinations thereof.

The electrically conductive agent may be present in the slurry in amounts of at least 0.1% by weight, such as at least 0.5% by weight, such as at least 1% by weight, such as at least 1.5% by weight, such as at least 2% by weight, based on the total solids weight of the slurry. The electrically conductive agent may be present in the slurry in amounts of no more than 20% by weight, such as no more than 15% by weight, such as no more than 10% by weight, such as no more than 7.5% by weight, such as no more than 5% by weight, such as no more than 4% by weight, such as no more than 3% by weight, such as no more than 2.5% by weight, based on the total solids weight of the slurry. The electrically conductive agent may be present in the slurry in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The slurry composition may be in the form of an electrode slurry composition comprising the binder, electrochemically active material and electrically conductive material, each as described above. The electrode slurry may comprise such materials present in the slurry composition in the amounts described above. For example, the electrode slurry composition may comprise the electrochemically active material present in amounts of 45% to 95% by weight, such as 70% to 98% by weight; the binder solids from the binder composition present in amounts of 1% to 20% by weight, such as 1% to 10% by weight, such as 5% to 10% percent by weight; and the electrically conductive agent present in amounts of 1% to 20% by weight, such as 5% to 10% by weight, the percentages by weight based on the total solids weight of the electrode slurry composition.

The electrode slurry composition comprising the organic medium, electrochemically active material, electrically conductive material, binder dispersion (which may include a separately added crosslinking agent), additional organic medium, if needed, and optional ingredients, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The slurry composition may have a solids content of at least 30% by weight, such as at least 40% by weight, such as at least 50% by weight, such as at least 55%, such as at least 60%, such as at least 65%, such as at least 71%, such as at least 75%, and may be no more than 90% by weight, such as no more than 85% by weight, such as no more than 75% by weight, the % by weight based on the total weight of the slurry composition. The slurry composition may have a solids content of 30% to 90% by weight, such as 40% to 85% by weight, such as 50% to 85% by weight, such as 55% to 85% by weight, such as 60% to 85% by weight, such as 65% to 85% by weight, such as 71% to 85% by weight, such as 75% to 85% by weight, based on the total weight of the slurry composition.

The present disclosure is also directed to an electrode comprising an electrical current collector and a film on the electrical current collector, wherein the film comprises: (1) an electrochemically active material; and (2) a binder comprising: (a) at least one fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers. The film may be deposited from the electrode slurry composition described above. The electrode may be a positive electrode or a negative electrode and may be manufactured by applying the above-described slurry composition to the surface of the current collector to form a coating film, and subsequently drying and/or curing the coating film. The coating film may have a thickness of at least 1 micron, such as 1 to 500 microns (μm), such as 1 to 150 μm, such as 25 to 150 μm, such as 30 to 125 μm. The coating film may comprise a cross-linked coating, and the film may further comprise the residue of a crosslinking agent. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the organic medium is removed may be 25 to 150 microns (μm), such as 30 to 125 μm.

Drying and/or crosslinking the coating film after application, if applicable, can be done, for example, by heating at elevated temperature, such as at least 50° C., such as at least 60° C., such as 50−145° C., such as 60−120° C., such as 65−110° C. The time of heating will depend somewhat on the temperature. Generally, higher temperatures require less time for curing. Typically, curing times are for at least 5 minutes, such as 5 to 60 minutes. The temperature and time should be sufficient such that the (meth)acrylic polymer in the cured film is crosslinked (if applicable), that is, covalent bonds are formed between co-reactive groups on the (meth)acrylic polymer polymer chain, such as carboxylic acid groups and hydroxyl groups and the N-methylol and/or the N-methylol ether groups of an aminoplast, isocyanato groups of a blocked polyisocyanate crosslinking agent, or in the case of a self-curing (meth)acrylic polymer, the N-alkoxymethyl amide groups or blocked isocyanato groups. The extent of cure or crosslinking may be measured as resistance to solvents such as methyl ethyl ketone (MEK). The test is performed as described in ASTM D-540293. The number of double rubs, one back and forth motion, is reported. This test is often referred to as “MEK Resistance”. Accordingly, the (meth)acrylic polymer and crosslinking agent (inclusive of self-curing (meth)acrylic polymers and (meth)acrylic polymers with separately added crosslinking agents) is isolated from the binder composition, deposited as a film and heated for the temperature and time that the binder film is heated. The film is then measured for MEK Resistance with the number of double rubs reported. Accordingly, a crosslinked (meth)acrylic polymer will have an MEK Resistance of at least 50 double rubs, such as at least 75 double rubs. Also, the crosslinked (meth)acrylic polymer may be substantially solvent resistant to the solvents of the electrolyte mentioned below. Other methods of drying the coating film include ambient temperature drying, microwave drying and infrared drying, and other methods of curing the coating film include e-beam curing and UV curing.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present disclosure is also directed to an electrical storage device. An electrical storage device can be manufactured by using the above electrodes prepared from the electrode slurry composition of the present disclosure. The electrical storage device comprises an electrode, a counter electrode and an electrolyte. The electrode, counter-electrode or both may comprise the electrode of the present disclosure, as long as one electrode is a positive electrode, and one electrode is a negative electrode. Electrical storage devices include, but are not limited to, a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as 7-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L, such as 0.8 to 1.5 mole/L, such as 0.85 to 1.25 mole/L.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography using a polystyrene standard according to ASTM D6579−11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). As used herein, the term “number average molecular weight” or “(Mₙ)” means the number average molecular weight (Mₙ) as determined by gel permeation chromatography using a polystyrene standard according to ASTM D6579−11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the binder and/or slurry composition and specifically excludes the organic medium.

As used herein, the term “residue of” when referring to the composition of a polymer refers to a singular molecular unit within the polymer that results from incorporation (i.e., reaction) of a monomer during polymerization.

As used herein, the term “consists essentially of” includes the recited material or steps and those that do not materially affect the basic and novel characteristics of the binder composition, slurry composition, electrode, or electrical storage device.

As used herein, the term “consists of” excludes any element, step or ingredient not recited.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “a” (meth)acrylic polymer, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the disclosure have been described in terms of “comprising”, embodiments consisting essentially of or consisting of are also within the scope of the present disclosure.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof. Each of the characteristics and examples described herein, and combinations thereof, may be said to be encompassed by the present disclosure.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

EX 1.

Chemical Suppliers

All acrylic monomers are available from BASF or Dow Chemical Company. Trigonox is available from AkzoNobel. PVDF was obtained from Shanghai 3F (T-1 PVDF, “PVDF 1”) and Solvay (PVDF Solef 5130, “PVDF 2”). Triethylphosphate (“TEP”) and ethyl acetoacetate (“EAA”) are both available from the Eastman Chemical Company. Conductive carbons Super P and C₆₅ are both available from Gelon. NMC811 is also available from Gelon. Resimene HM-2608 (90% active material in isobutanol) was obtained from INEOS. A 10% active material solution of Resimene HM-2608 was prepared in TEP (“additive solution Z”).

### Synthesis of (Meth)Acrylic Polymers

The following table contains abbreviations or trade names of solvents, radical initiators, or (meth)acrylic monomer used in the examples:

| J 0Abbreviation or | | |
|---|---|---|
| Trade Name | Role | Chemical Name |
| TEP | Solvent | Triethyl phosphate |
| EAA | Solvent | Ethyl acetoacetate |
| Trigonox 131 | Radical | tert-Amylperoxy 2-ethylhexyl |
| | initiator | carbonate |
| NVP | Monomer | N-Vinyl pyrrolidone |
| MMA | Monomer | Methyl methacrylate |
| EHA | Monomer | 2-Ethylhexyl acrylate |
| EA | Monomer | Ethyl acrylate |
| HEA | Monomer | 2-Hydroxyethyl acrylate |
| MAA | Monomer | Methacrylic acid |
| GMA | Monomer | Glycidyl methacrylate |

### Synthesis of Resin A

In a four neck round bottom flask, 324.3 grams of triethyl phosphate (TEP) was added and the flask was set up with a mechanical stir blade, thermocouple, and reflux condenser. The flask containing TEP solvent was heated to a set point of 120° C. under a nitrogen atmosphere. A monomer solution containing 197.2 grams of MMA, 151.5 grams of EHA, 135.6 grams of EA, 9.9 grams of HEA, and 9.9 grams of MAA was thoroughly mixed. A solution of 10.3 grams of Trigonox 131 and 138.9 grams of TEP was prepared and added into the flask via an addition funnel over 360 minutes. Five minutes after the initiator solution started, the monomer solution was added into flask via an addition funnel over 300 minutes. After the monomer feed was complete, the monomer addition funnel was rinsed with 12.4 grams of TEP. After the initiator feed was complete, the initiator addition funnel was rinsed with 12.4 grams of TEP. The reaction was then held at 120° C. for 60 minutes. After the 60-minute hold, the reaction was cooled and poured into a suitable container. The final measured solids of the resin was determined to be 51.0% solids.

The solids content of the (meth)acrylic polymers were measured in each (meth)acrylic polymer example by the following procedure: An aluminum weighing dish from Fisher Scientific, was weighed using an analytical balance. The weight of the empty dish was recorded to four decimal places. Approximately 0.5 g of dispersant was added to the weighed dish and the weight of the dish and the (meth)acrylic polymer solution was recorded to four decimal places. Next approximately 3.5 g of acetone was added to the weighing dish. The dish containing the (meth)acrylic polymer solution and acetone was placed into a laboratory oven, with the oven temperature set to 110 degrees centigrade, and dried for 1 hour. The dish and dried (meth)acrylic polymer were weighed using an analytical balance. The weight of the dish and dried (meth)acrylic polymer was recorded to four decimal places. The solids content was determined using the following equation: % solids=100× [(weight of the dish and the dry (meth)acrylic polymer)−(weight of the empty dish)]/[(weight of the dish and the (meth)acrylic polymer solution)−(weight of the empty dish)].

### Synthesis of Resin B

In a four neck round bottom flask, 324.3 grams of triethyl phosphate (TEP) was added and the flask was set up with a mechanical stir blade, thermocouple, and reflux condenser. The flask containing TEP solvent was heated to a set point of 125° C. under a nitrogen atmosphere. A monomer solution containing 197.1 grams of MMA, 186.3 grams of EHA, 50.4 grams of EA, 50.4 grams of NVP, 9.9 grams of HEA, and 9.9 grams of MAA was thoroughly mixed. A solution of 10.3 grams of Trigonox 131 and 138.9 grams of TEP was prepared and added into the flask via an addition funnel over 360 minutes. Five minutes after the initiator solution started, the monomer solution was added into flask via an addition funnel over 300 minutes. After the monomer feed was complete, the monomer addition funnel was rinsed with 12.4 grams of TEP. After the initiator feed was complete, the initiator addition funnel was rinsed with 12.4 grams of TEP. The reaction was then held at 125° C. for 60 minutes. After the 60-minute hold, the reaction was cooled and poured into a suitable container. The final measured solids of the resin was determined to be 51.0% solids.

### Synthesis of Resin C

In a four neck round bottom flask, 324.3 grams of triethyl phosphate (TEP) was added and the flask was set up with a mechanical stir blade, thermocouple, and reflux condenser. The flask containing TEP solvent was heated to a set point of 120° C. under a nitrogen atmosphere. A monomer solution containing 197.2 grams of MMA, 167.4 grams of EHA, 79.1 grams of EA, 50.4 grams of GMA, and 9.95 grams of HEA was thoroughly mixed. A solution of 12.19 grams of Trigonox 131 and 140.6 grams of TEP was prepared and added into the flask via an addition funnel over 360 minutes. Five minutes after the initiator solution started, the monomer solution was added into flask via an addition funnel over 300 minutes. After the monomer feed was complete, the monomer addition funnel was rinsed with 12.4 grams of TEP. After the initiator feed was complete, the initiator addition funnel was rinsed with 12.4 grams of TEP. The reaction was then held at 120° C. for 60 minutes. After the 60-minute hold, the reaction was cooled and poured into a suitable container. The final measured solids of the resin was determined to be 51.0% solids.

### Preparation of Binder Compositions

### Preparation of PVDF Dispersion (Control Binder)—Binder Dispersion B1

A dispersion of PVDF was prepared in a mixture of TEP and EAA by the addition of resin A, resin B, resin C, PVDF 1, and PVDF 2 on a 12.2-gram scale. A total of 403 mg of (meth)acrylic polymer and 1.26 grams of PVDF were used to make the binder dispersion, “B1”. The weight ratio of (meth)acrylic polymer was 2.0 parts resin A to 1.0 part resin B to 1.2 parts resin C. The weight ratio of PVDF was 1.86 parts PVDF 1 to 1.00 parts PVDF 2. The PVDF dispersion was prepared in two parts. The first part was prepared by the addition of resin C to 9.46 grams of TEP under high shear mixing. To this mixture was added PVDF 2. For the second part, 814 mg of TEP and 238 mg of EAA were combined under high shear mixing. To that solution was added resin A and resin B followed by PVDF 1. Both parts were combined to form control binder, “B1” which has a calculated total solids (by weight) of 12.0%.

### Preparation of PVDF Solution (Inventive Binder)—Binder Solution B2

A PVDF solution was prepared by dissolving resin A, resin B, resin C, PVDF 1, and PVDF 2 in TEP under high shear mixing using a Cowles blade on a 100-gram scale according to the follow procedure. A total of 2.20 grams of (meth)acrylic polymer and a total of 6.86 grams of PVDF were used in the preparation of binder solution “B2”. Resin A, resin B, and resin C were all added to 90.95 grams of TEP and agitated until dissolved. Next, PVDF 1 was added to the solubilized (meth)acrylic polymer in two portions. When the solution was clear, PVDF 2 was then added and agitated under high shear. The weight ratios of (meth)acrylic polymer as well as the weight ratios of PVDF were identical to those used in the mixing of binder dispersion B1. Binder solution B2 had a total solids of 8.0% (by weight).

### Preparation of Positive Electrode Slurries

Method 1: General Procedure TEP-Based Positive Electrode Slurry (S1 and S2)

In a nitrogen filled glove bag, the binder solution was diluted with TEP or a mixture of TEP/EAA and added to a Thinky cup. Next conductive carbon was added and mixed with a wooden blade by hand. The Thinky cup was capped and removed from the glove bag. Dispersion of the carbon was achieved using a centrifugal mixer. Once homogenous, the carbon slurry was returned to the glove bag, uncapped, and the active material was added. The active material/carbon slurry was mixed by hand using a wooden blade, capped, and removed from the glove bag. Dispersion of the active material was achieved using a centrifugal mixer. Once homogenous, the carbon/active material slurry was returned to the glove bag, uncapped, and the additive solution was added. The fully formulated positive electrode slurry was mixed by hand using a wooden blade, capped, and removed from the glove bag. Final dispersion of all of the positive electrode slurry components was completed using a centrifugal mixer.

### Preparation of Comparative TEP/EAA Positive Electrode Slurry—Slurry S1

This slurry was prepared on a 101.1-gram scale with a weight ratio of 95% active material to 3% conductive carbon to 2% binder. Table 1 provides the exact weights of the components used in the preparation of slurry S1 according to method 1. The weight % solids of the slurry was 73%.

TABLE 1
Slurry S1 components

| Component | Role | Amount (grams) |
|---|---|---|
| NCM811 | Active Material | 70.00 |
| Super P | Conductive Carbon | 1.47 |
| C65 | Conductive Carbon | 0.74 |
| Binder B1 | Binder | 12.18 |
| TEP | Diluent | 15.42 |
| EAA | Diluent | 1.13 |
| Additive Solution Z | Additive | 0.21 |

### Preparation of Inventive TEP Positive Electrode Slurry—Slurry S2

This slurry was prepared on a 101.1-gram scale with a weight ratio of 95% active material to 3% conductive carbon to 2% binder. Table 2 provides the exact weights of the components used in the preparation of slurry S2 according to method 1. The weight % solids of the slurry was 73%.

TABLE 2
Slurry S2 components

| Component | Role | Amount (grams) |
|---|---|---|
| NCM811 | Active Material | 70.00 |
| Super P | Conductive Carbon | 1.47 |
| C65 | Conductive Carbon | 0.74 |
| Binder B2 | Binder | 18.42 |
| TEP | Diluent | 10.30 |
| Additive Solution Z | Additive | 0.21 |

### Evaluation of Slurry Stability

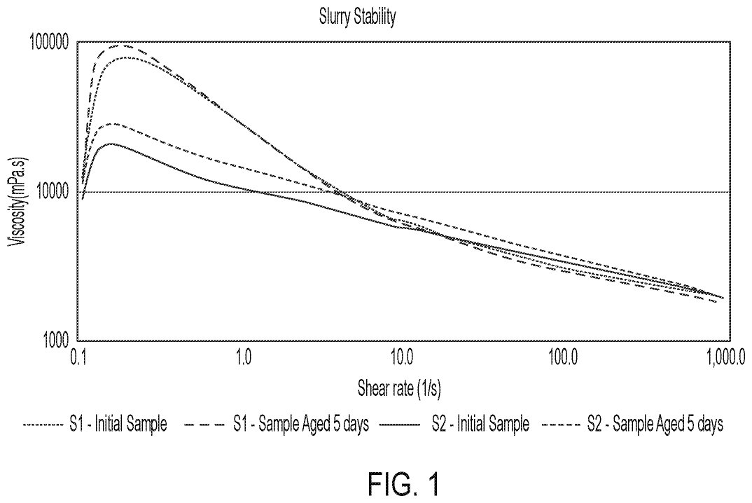

The rheology of slurry S1 and S2 were initially evaluated then were sealed with a cap and allowed to age at room temperature (23° C.) for five days. After aging the samples, the rheology was re-evaluated. These results are depicted in FIG. 1. Notably, the viscosity at low shear rates (less than 10 s⁻¹) is lower for S2 (with the solubilized PVDF) compared to S1 (with dispersed PVDF). S1 demonstrated unchanged viscosity after 5 days of aging whereas S2 showed about a 30% increase in viscosity after 5 days, particularly at low shear rates. The increase in viscosity means the slurry is losing stability and starting to gel. However, at higher shear rates (greater than 10 s⁻¹), the viscosities of the initial samples and aged samples for both S1 and S2 are much closer in magnitude.

### Preparation of Electrode Films

Electrode films cast from slurry S1 and slurry S2 were prepared using a 200 micron draw down bar on a draw down table onto aluminum foil. Then, the deposited films were oven-dried for two minutes at 80° C. then for four minutes at 120° C. Each film was pressed using a calendar press to a porosity of 33% resulting in a film thickness ranging from 63 to 65 microns. The coating weight of the deposited positive electrode was 20.4 mg/cm² from slurry S1 and 20.6 mg/cm² from slurry S2.

### Evaluation of Battery Electrode Adhesion

Strips of coated electrode were cut 0.5 inches and affixed to an untreated aluminum panel using 3M 444 double sided tape. The adhesive strength of two strips of coated electrode were evaluated for both S1 and S2 electrodes using a 90-degree peel test on MARK-10 ESM303 at a speed of 50 mm/min. The average peel strength was 4 N/m for the positive electrode from S1 compared to 14 N/m for the positive electrode from S2. This demonstrated that the lower peel strength observed with binder B1/slurry S1 from the dispersed PVDF can be improved when a solution of PVDF (as in binder B2/slurry S2) is used to prepare positive electrode films.

Accordingly, despite the slight decrease in positive electrode slurry stability noted with a binder comprising solubilized PVDF, an improvement of 3× was observed in adhesion performance compared to a binder comprised of dispersed PVDF.

EX 2.

Chemical Suppliers

Distilled N-methylpyrrolidone (“NMP”) can be purchased from BASF.

Method 2: General Prep for Positive Electrode Slurry at Ambient Conditions (S3 and S4)

Positive electrode slurries were prepared at room temperature (23° C.) with a humidity of 45−55% (not in a dry bag). First, the binder (B2 or PVDF 2) was dissolved in the diluent (TEP or NMP) in a Thinky cup. Next conductive carbon was added and mixed with a wooden blade by hand. Dispersion of the carbon was achieved using a centrifugal mixer. Once homogenous, the active material was then added. The active material/carbon slurry was mixed by hand using a wooden blade. Dispersion of the active material was achieved using a centrifugal mixer. Once homogenous, the additive solution Z was added, where noted. The fully formulated positive electrode slurry was mixed by hand using a wooden blade. Final dispersion of all of the positive electrode slurry components was completed using a centrifugal mixer.

### Preparation of Inventive TEP Positive Electrode Slurry—Slurry S3

This slurry was prepared on a 43.7-gram scale with a weight ratio of 95% active material to 3% conductive carbon to 2% binder according to method 2. Table 3 provides the exact weights of the components used in the preparation of slurry S3 according to method 2. The weight % solids of the slurry was 73%.

TABLE 3
Slurry S3 components

| Component | Role | Amount (grams) |
|---|---|---|
| NCM811 | Active Material | 30.00 |
| Super P | Conductive Carbon | 0.95 |
| C65 | Conductive Carbon | 0.32 |
| Binder solution B2 | Binder | 7.89 |
| TEP | Diluent | 4.42 |
| Additive Solution Z | Additive | 0.10 |

### Preparation of Comparative NMP Positive Electrode Slurry—Slurry S4

This slurry was prepared on a 48.2-gram scale with a weight ratio of 95% active material to 3% conductive carbon to 2% binder according to method 2. Table 4 provides the exact weights of the components used in the preparation of slurry S4. The weight % solids of the slurry was 66%.

TABLE 4
Slurry S4 components

| Component | Role | Amount (grams) |
|---|---|---|
| NCM811 | Active Material | 30.00 |
| Super P | Conductive Carbon | 0.95 |
| C65 | Conductive Carbon | 0.32 |
| PVDF 2 | Binder | 0.63 |
| NMP | Diluent | 16.27 |

### Preparation of Electrode Films

Electrode films cast from slurry S3 and slurry S4 were prepared (cast and dried) in the same manner as described in Example 1. Films cast from slurry S3 and slurry S4 were pressed using a calendar press to a porosity of 30−35% resulting in a film thickness ranging from 55 to 65 microns. The coating weight of the deposited film was approximately 20 mg/cm² for each electrode film.

### Evaluation of Battery Electrode Adhesion

Adhesion testing for positive electrode films resulting from slurry S3 and slurry S4 was conducted in the same manner as described in Example 1. The average peel strength was 13 N/m for the positive electrode from S3 compared to 14 N/m for the positive electrode from S4. This demonstrated that under similar application conditions S3 and S4 delivered comparable adhesion results.

Accordingly, the TEP-based binder B2 used to make S3 electrodes demonstrated comparable adhesion strength compared to the standard PVDF in NMP binder. However, the TEP-based binder B2 could be made at higher solids content than the NMP-based binder, and TEP has less health and environmental risk than NMP.

EX 3.

### Preparation of Binder Compositions

### Preparation of PVDF Dispersion (Control Binder)—Binder Dispersion B3

Binder dispersion B3 was prepared in a mixture of TEP and EAA in a manner analogous to binder dispersion B1 in example 1 using the same (meth)acrylic polymer weight ratios and PVDF weight ratios.

### Preparation of PVDF Solution (Inventive Binder)—Binder Solution B4

Binder solution B4 was prepared in TEP in a manner analogous to binder solution B2 in example 1 using the same (meth)acrylic polymer weight ratios and PVDF weight ratios.

### Preparation of PVDF Solutions (Inventive Binders)—Binders B5, B6, B7, B8, B9

These binder solutions in TEP were prepared in a manner analogous to binder solution B2 in example 1 with different (meth)acrylic polymer weight ratios and different PVDF weight ratios than Binder solution B2. The exact weight ratios of (meth)acrylic polymer and exact weight ratio of PVDF are found in Table 5 normalized to 100% of the total solids based on weight. Binder solutions B5, B6, B7, B8, and B9 all were prepared at 8.0% total solids by weight.

TABLE 5
Weight % composition of inventive binders B5, B6,
B7, B8, and B9 based on weight of total solids

| | PVDF 1 | PVDF 2 | Resin A | Resin B | Resin C |
|---|---|---|---|---|---|
| Binder B5 | 30.0% | 55.8% | 14.2% | — | — |
| Binder B6 | 30.0% | 55.8% | — | 14.2 | — |
| Binder B7 | 30.0% | 55.8% | — | — | 14.2 |
| Binder B8 | 30.0% | 55.8% | — | 7.1 | 7.1 |
| Binder B9 | 30.0% | 45.8% | — | 12.1 | 12.1 |

### Evaluation of Binder Rheology

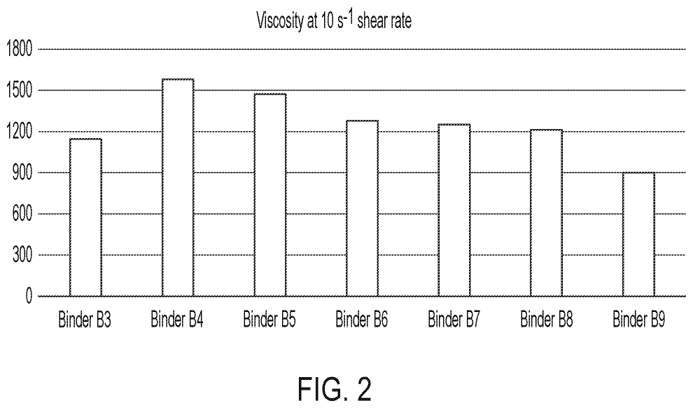

The rheology of binder compositions B3 to B9 were evaluated by measuring the viscosity (cP) as a function of shear rate. FIG. 2 shows the viscosity of each binder at a shear rate of 10s⁻¹.

As shown in FIG. 2, Resins B and C were more effective at reducing viscosity than Resin A when comparing binder compositions B6/B7 to binder composition B5. These results indicate that inclusion of heterocyclic (meth)acrylic monomers may reduce binder composition viscosity. Moreover, lower levels of PVDF offset by higher levels of (meth)acrylic polymer reduce the binder composition viscosity when comparing binder composition B8 to binder composition B9.

### Preparation of Positive Electrode Slurries

Method 3: General Procedure for the Preparation of Positive Electrode Slurries for Example 3

In a nitrogen filled glove bag, the binder solution was diluted with NMP, TEP or a mixture of TEP/EAA and added to a Thinky cup. Next conductive carbon was added and mixed with a wooden blade by hand. The Thinky cup was capped and removed from the glove bag. Dispersion of the carbon was achieved using a centrifugal mixer. Once homogenous, the carbon slurry was returned to the glove bag, uncapped, and the active material was added. The active material/carbon slurry was mixed by hand using a wooden blade, capped, and removed from the glove bag. Dispersion of the active material was achieved using a centrifugal mixer. Once homogenous, the carbon/active material slurry was returned to the glove bag, uncapped, and the additive solution was added, where noted. The fully formulated positive electrode slurry was mixed by hand using a wooden blade, capped, and removed from the glove bag. Final dispersion of all of the positive electrode slurry components was completed using a centrifugal mixer.

### Preparation of Inventive Positive Electrode Slurries S5, S6, S7, S8, S9, S10

These slurries were prepared according to the general procedure described in method 3 and in all cases the additive solution Z was used. Table 6 indicated the binders used in to prepare each slurry. Table 8 shows the weight % of each component based on the total solids. The weight % solids of the slurry was 73% based on total weight of the composition.

TABLE 6
Inventive Binder Codes and Inventive Slurry Codes

| Inventive Slurry Codes | Binder Used to Make Slurry |
|---|---|
| Slurry S5 | Binder B5 |
| Slurry S6 | Binder B6 |
| Slurry S7 | Binder B7 |
| Slurry S8 | Binder B8 |
| Slurry S9 | Binder B9 |
| Slurry S10 | Binder B4 |

TABLE 7
Components of Inventive Slurries S5, S6, S7, S8, S9, and S10

| | | Weight % based |
|---|---|---|
| Component | Role | total solids* |
| NCM811 | Active Material | 95.0% |
| Super P | Conductive Carbon | 2.2% |
| C65 | Conductive Carbon | 0.8% |
| Binder B5, B6, B7, B8, | Binder | 2.0% |
| B9, or B4 | | |

*Additive solution Z was added at the same level as in slurry S2 but was not included in the calculation in Table 7.

### Preparation of NMP Control Positive Electrode Slurry S11

This positive electrode slurry was prepared using HSV900 PVDF available from Arkema, “PVDF 3”. It was prepared according to method 3. Table 8 shows the weight % of each component based on the total solids. The weight % solids of the slurry was 68% based on total weight of the composition.

TABLE 8
Slurry S11 components

| Component | Role | Weight % based total solids |
|---|---|---|
| NCM811 | Active Material | 95.0% |
| Super P | Conductive Carbon | 2.2% |
| C65 | Conductive Carbon | 0.8% |
| PVDF 3 | Binder | 2.0% |

### Preparation of PVDF-Dispersion Positive Electrode Slurry S12

This positive electrode slurry was prepared in a manner analogous to slurry S1 according to method 3 (and included additive solution Z). Binder composition B3 was used to formulate slurry S11. This slurry was prepared with a weight ratio of 95% active material to 3% conductive carbon to 2% binder based on the total solids (not including the additive solution Z). The weight % solids of the slurry was 73% based on total weight of the composition.

### Preparation of Electrode Films

Electrode films cast from slurries S5 to S12 were prepared (cast and dried) in the same manner as described in Example 1. Films cast from slurry S5 to slurry S12 were pressed using a calendar press to a porosity of 30−35% resulting in a film thickness ranging from 55 to 65 microns. The coating weight of the deposited film was approximately 20 mg/cm² for each electrode film.

### Evaluation of Battery Electrode Adhesion

Adhesion testing for positive electrode films resulting from slurries S5 to S12 was conducted in the same manner as described in example 1. The average peel strength is shown in Table 9 below.

TABLE 9
Comparison of Adhesion Testing for Example 3

| | | Peel |
|---|---|---|
| | | Strength |
| Slurry | Description | (N/m) |
| S5 | Inventive Examples with Fluoropolymer | 17 |
| S6 | Dissolved in TEP | 16 |
| S7 | | 12 |
| S8 | | 12 |
| S9 | | 11 |
| S10 | | 14 |
| S11 | Control with Fluoropolymer Dissolved in NMP | 19 |
| S12 | Control with Fluoropolymer Dispersed in TEP/EAA | 5 |

When (meth)acrylic polymers are used to prepare slurry compositions comprising a PVDF solution (S5 to S10), higher adhesion strength is noted when compared to a slurry composition comprising a (meth)acrylic polymer dispersing agent and dispersed PVDF (S12). Inventive examples S5 and S6 provided comparable adhesion to the NMP control at a higher % solids slurry, thus providing a benefit for the battery coaters by using less solvent. Lower solvent usage would reduce the energy cost of evaporating the solvent from the deposited electrode film.

Ex. 4

### Preparation of Binder Solutions

### Preparation of PVDF Dispersion (Control Binder)—Binder Dispersion B13

Binder dispersion B13 was prepared in a mixture of TEP and EAA in a manner analogous to binder dispersion B1 in example 1 using the same (meth)acrylic polymer weight ratios and PVDF weight ratios. Binder dispersion B13 had a total solids of 8.0% (by weight) and a viscosity of 202 cP at a shear rate of 10 per second using the method described above.

### Preparation of PVDF Solution (Inventive Binder)—Binder Solution B14

Binder solution B14 was prepared in TEP in a manner analogous to binder solution B2 in example 1 using the same (meth)acrylic polymer weight ratios and PVDF weight ratios. Binder solution B14 had a total solids of 8.1% (by weight) and a viscosity of 1161 cP at a shear rate of 10 per second using the method described above.

### Preparation of PVDF Solution (Inventive Binder)—Binder Solution B15

Binder solution B15 was prepared in a manner analogous to Binder solution B2 in example 1 except all of the PVDF in the composition was PVDF 2. Binder solution B15 had a total solids of 8.6% (by weight) and a viscosity of 3337 cP at a shear rate of 10 per second using the method described above.

### Preparation of PVDF Solution (Control Binder)—Binder Solution B16

Binder solution B16 was prepared in a manner analogous to Binder solution B2 in example 1 except no (meth)acrylic polymer was used and all of the PVDF in the composition was PVDF 2. Binder solution B16 had a total solids of 7.9% (by weight) and a viscosity of 6345 cP at a shear rate of 10 per second using the method described above.

Results of Viscosity Testing: An increase in the level of adhesion promoting fluoropolymer PVDF 2 increased the viscosity of the binder solutions (compare binder solution B14 with binder solutions B15 and B16). The addition of a (meth)acrylic polymer resulted in an offset of the observed viscosity increase in the presence of high levels of PVDF 2 (compare binder solutions B15 and B16).

### Preparation of Positive Electrode Slurries

### Preparation of Slurries S13, S14, S15, and S16 for Ex. 4

All slurries in Ex. 4 were prepared according to method 3 described in Ex. 3. The diluent used for each slurry is analogous to the organic medium described in preparation of binder compositions B13, B14, B15, and B16. The target viscosity for all slurries was 5500-7500 cP to be processable using a slot die coater. Table 10 indicated the binders used in to prepare each slurry. Table 11 shows the weight % of each component based on the total solids. The weight % solids of the slurry based on total weight of the composition is reported in Table 12.

TABLE 10
Binder Codes and Slurry Codes used for Inventive
Examples and Controls in Ex. 4.

| | Binder Composition Used to | Inventive or Control |
|---|---|---|
| Slurry Code | Make Slurry | Example |
| S13 | B13 | Control Example |
| S14 | B14 | Inventive Example |
| S15 | B15 | Inventive Example |
| S16 | B16 | Control Example |

TABLE 11
Components of Inventive Slurries S13, S14, S15, and S16

| | | Weight %, based |
|---|---|---|
| Component | Role | total solids* |
| NCM811 | Active Material | 95.0% |
| Super P | Conductive Carbon | 3.0% |
| Binder Composition B13, | Binder | 2.0% |
| B14, B15, or B16 | | |

*Additive solution Z was added at the same level as in slurry S2 but was not included in the calculation in Table 11 for slurry compositions S13, S14, and S15. Additive solution Z was not added in Slurry S16.

### Preparation of Electrode Films

Electrode films cast from slurries S13 to S16 were prepared (cast and dried) in the same manner as described in Example 1. Films cast from slurry S13 to slurry S16 were pressed using a calendar press to a porosity of 30−35% resulting in a film thickness ranging from 55 to 65 microns. The coating weight of the deposited film was approximately 20 mg/cm² for each electrode film.

### Evaluation of Battery Electrode Adhesion

Adhesion testing for positive electrode films resulting from slurries S13 to S16 was conducted in the same manner as described in example 1. The average peel strength is shown in Table 12 below.

TABLE 12
Comparison of Slurry Properties and Positive
Electrode Film Adhesion Testing for Example 4

| Slurry | Slurry Solids | Slurry Viscosity | Peel Strength |
|---|---|---|---|
| Composition | (%) | (cP)* | (N/m) |
| S13 | 74.0% | 6739 | 20.2 |
| S14 | 74.1% | 6588 | 30.9 |
| S15 | 71.3% | 7173 | 70.6 |
| S16 | 67.7% | 5919 | 42.5 |

*Slurry viscosity value reported at 10 per second shear rate was collected in the manner previously described.

The results demonstrate that the inclusion of the (meth)acrylic polymer as part of a positive electrode binder, whether in a PVDF-dispersion (S13) or PVDF-solution (S14 and S15), provided an increase in the solids over a TEP-based PVDF solution without (meth)acrylic polymer (S16; compare 71−74% vs. 68%). In general, PVDF-solution binders increased adhesion compared to a PVDF-dispersion binder of S13. Increasing the level of adhesion promoting PVDF-2 further enhanced the peel strength (e.g., S15-S16), but inclusion of the (meth)acrylic polymer with increased level of PVDF-2 resulted in an unexpected further increase in peel strength (e.g., S15), indicating a synergistic effect.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A binder composition comprising:
(a) at least one fluoropolymer comprising the residue of vinylidene fluoride;
(b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and
(c) an organic medium comprising a trialkyl phosphate solvent, wherein the fluoropolymer is solubilized in the trialkyl phosphate solvent.

2. The binder composition of claim 1, wherein the trialkyl phosphate comprises triethyl phosphate.

3-7. (canceled)

8. The binder composition of claim 1, wherein the ethylenically unsaturated monomer comprising a heterocyclic group comprises vinyl pyrrolidone or an epoxide functional ethylenically unsaturated monomer.

9. (canceled)

10. The binder composition of claim 1, wherein the (meth)acrylic polymer comprises at least one of: (b1) a (meth)acrylic polymer (1) comprising constitutional units comprising the residue of: (i) 55% to 75% by weight of an alkyl ester of (meth)acrylic acid containing from 1 to 3 carbon atoms in the alkyl group; (ii) 20% to 40% by weight of an alkyl ester of (meth)acrylic acid containing from 4 to 18 carbon atoms in the alkyl group; (iii) 0.1% to 5% by weight of a hydroxyalkyl ester; and (iv) 0.1% to 5% by weight of an alpha, beta-ethylenically unsaturated carboxylic acid; (b2) an (meth)acrylic polymer (2) comprising constitutional units comprising the residue of: (i) 40% to 60% by weight of an alkyl ester of (meth)acrylic acid containing from 1 to 3 carbon atoms in the alkyl group; (ii) 25% to 48% by weight of an alkyl ester of (meth)acrylic acid containing from 4 to 18 carbon atoms in the alkyl group; (iii) 0.1% to 5% by weight of a hydroxyalkyl ester; (iv) 0.1% to 5% by weight of an alpha, beta-ethylenically unsaturated carboxylic acid; and (v) 0% to 20% by weight of an ethylenically unsaturated monomer comprising a heterocyclic group; and/or (b3) an (meth)acrylic polymer (3) comprising constitutional units comprising the residue of: (i) 45% to 65% by weight of an alkyl ester of (meth)acrylic acid containing from 1 to 3 carbon atoms in the alkyl group; (ii) 25% to 48% by weight of an alkyl ester of (meth)acrylic acid containing from 4 to 18 carbon atoms in the alkyl group; (iii) 0.1% to 5% by weight of a hydroxyalkyl ester; and (v) 0% to 20% by weight of an ethylenically unsaturated monomer comprising a heterocyclic group.

11. The binder composition of claim 10, wherein the fluoropolymer comprises (a1) a polyvinylidene fluoride homopolymer and (a2) a vinylidene fluoride copolymer, and the binder composition comprises: (a1) 10% to 50% by weight of the polyvinylidene fluoride homopolymer; (a2) 35% to 75% by weight of the vinylidene fluoride copolymer; the (meth)acrylic polymer comprising at least one of: (b1) 1% to 15% by weight of the (meth)acrylic polymer (1); (b2) 1% to 15% by weight of the (meth)acrylic polymer (2); and/or (b3) 1% to 15% by weight of the (meth)acrylic polymer (3); the % by weight based on the total weight of the resin solids.

12. The binder composition of claim 1, wherein the fluoropolymer and the (meth)acrylic polymer are not bound by a covalent bond.

13. The binder composition of claim 1, further comprising a cross-linker.

14. The binder composition of claim 1, wherein the (meth)acrylic polymer is self-crosslinking.

15. The binder composition of claim 1, wherein the fluoropolymer comprises an adhesion promoting fluoropolymer, wherein the adhesion promoting fluoropolymer comprises a polyvinylidene fluoride copolymer comprising constitutional units comprising the residue of vinylidene fluoride and at least one of (i) a (meth)acrylic acid; and/or (ii) a hydroxyalkyl (meth)acrylate.

16-22. (canceled)

23. The binder composition of claim 1, wherein the (meth)acrylic polymer is solubilized in the trialkyl phosphate solvent.

24-31. (canceled)

32. The binder composition of claim 1, wherein the binder composition comprises:
a first fluoropolymer having a weight average molecular weight of 250,000 to 700,000 g/mol, and
a second fluoropolymer having a weight average molecular weight of 750,000 to 1,500,000 g/mol.

33. (canceled)

34. A slurry composition comprising:
the binder composition of claim 1; and
an electrochemically active material.

35. The slurry composition of claim 34, wherein the electrochemically active material comprises a material capable of incorporating lithium comprising LiCoO₂, LiNiO₂, LiFePO₄, LiCoPO₄, LiMnO₂, LiMn₂O, Li(NiMnCo)O₂, Li(NiCoAl)O₂, carbon-coated LiFePO₄, or a combination thereof.

36. (canceled)

37. The slurry composition of claim 34, wherein the electrochemically active material comprises a material capable of lithium conversion comprising sulfur, LiO, FeF₂ and FeF₃, Si, aluminum, tin, SnCo, Fe₃O₄, or combinations thereof.

38. (canceled)

39. The slurry composition of claim 34, wherein the electrochemically active material comprises graphite, silicon compounds, tin, tin compounds, sulfur, sulfur compounds, or a combination thereof.

40. The slurry composition of claim 34, wherein the slurry composition further comprises an electrically conductive agent.

41. (canceled)

42. A slurry composition comprising:
the binder composition of claim 1; and
an electrically conductive agent.

43-44. (canceled)

45. An electrode comprising:
(a) an electrical current collector; and
(b) a film on the electrical current collector, wherein the film comprises:
(1) an electrochemically active material; and
(2) a binder comprising:
(a) at least one fluoropolymer comprising the residue of vinylidene fluoride; and
(b) one or more (meth)acrylic polymers comprising constitutional units comprising the residue of:
(i) 40% to 80% by weight of an alkyl ester of (meth)acrylic acid containing from 1 to 3 carbon atoms in the alkyl group;
(ii) 18% to 48% by weight of an alkyl ester of (meth)acrylic acid containing from 4 to 18 carbon atoms in the alkyl group;
(iii) 0.1% to 10% by weight of a hydroxyalkyl ester;
(iv) 0% to 10% by weight of an alpha, beta-ethylenically unsaturated carboxylic acid; and
(v) 0% to 20% by weight of an ethylenically unsaturated monomer comprising a heterocyclic group, the % by weight based on the total monomer weight that comprise the one or more (meth)acrylic polymers.

46-48. (canceled)

49. The electrode of claim 45, wherein the film is cross-linked.

50-54. (canceled)

55. An electrical storage device comprising:
(a) the electrode of claim 45;
(b) a counter electrode; and
(c) an electrolyte.

56-58. (canceled)
